(19) United States
(12) Patent Application Publication
(10) Pub. No.: US 2025/0222635 A1
(43) Pub. Date: Jul. 10, 2025

(54) METHOD AND APPARATUS FOR PRODUCING SEAT PAD REINFORCING CLOTH, AND MOLDING DIE

(71) Applicant: MOLD TECHNICAL OFFICE CO., LTD., Ninomiyamachi, Naka-gun (JP)

(72) Inventors: Tatsuya WAKI, Ninomiyamachi, Naka-gun (JP); Eiji YAMAMOTO, Ninomiyamachi, Naka-gun (JP); Futoshi TAKAHASHI, Ninomiyamachi, Naka-gun (JP); Ryou IWASAWA, Ninomiyamachi, Naka-gun (JP)

(21) Appl. No.: 18/718,548

(22) PCT Filed: Feb. 20, 2023
(86) PCT No.: PCT/JP2023/005969

§ 371 Date: Jun. 11, 2024

(30) Foreign Application Priority Data
May 11, 2022 (JP) 2022-078067

(51) Int. Cl. B29C 44/14; B29C 44/58; B29C 59/16; B29K 75/00; B29L 31/58

(52) U.S. Cl. CPC B29C 44/14; B29C 44/58; B29C 59/16; B29K 2075/00; B29L 2031/58

(57) ABSTRACT

Provided are a manufacturing method and a manufacturing apparatus for a seat-pad reinforcing cloth, and a molding die, with which urethane foam grows uniformly even in a thinnest wall part of a urethane seat pad, and even when a seat-pad reinforcing cloth has a complicated shape, it is not required to prepare a larger material, and deburring work is not required, thereby enabling eliminating manual work as much as possible. The manufacturing method includes: a step of putting a seat-pad reinforcing cloth material over a molding die; an upper-end-portion heat-pressing molding step of performing heat-pressing molding on an upper end portion of a seat upper ridge line portion of the seat-pad reinforcing cloth material put over the molding die, from above by an upper-end-portion heat-pressing molding device, to generate creases in a periphery of a rear part of a portion of the seat-pad reinforcing cloth material, which has been subjected to the heat-pressing molding from above; a rear-portion heat-pressing molding step of performing heat-pressing molding by a rear-portion heat-pressing molding device, together with the creases generated in the upper-end-portion heat-pressing molding step; and a front-portion heat-pressing molding step of performing heat-pressing molding by a front-portion heat-pressing molding device.

### TECHNICAL FIELD

The present invention relates to a manufacturing method and a manufacturing apparatus for a seat-pad reinforcing cloth to be used for a urethane seat pad for a vehicular seat, and also relates to a molding die.

### BACKGROUND ART

A urethane seat pad to be used for an automobile seat being a vehicular seat is illustrated in FIG. 23 and FIG. 24. As illustrated in FIG. 23 and FIG. 24, a urethane seat pad 102 is used for a seat back part (backrest part) 100 of the automobile seat. A seat-pad reinforcing cloth (also called “nonwoven fabric spring receiving member”) 104 is attached to a rear surface of the urethane seat pad. The seat-pad reinforcing cloth 104 is manufactured by molding or three-dimensionally sewing a seat-pad reinforcing cloth material 105 having a shape as illustrated in FIG. 25.

As illustrated in FIG. 26 (a direction of a longitudinal section taken along the line A-A of FIG. 23) and FIG. 27 (a direction of a partial transverse section taken along the line B-B of FIG. 24), this urethane seat pad 102 is manufactured as follows. When dedicated foaming molds 106 (lower mold), 108 (middle mold) and 110 (upper mold) are in a mold opened state, the seat-pad reinforcing cloth 104 is attached and set to the molds, and a urethane raw liquid 112 is injected into the molds. After that, the molds are closed to perform foaming (foam growth and resin solidification) inside the molds, and the molds are heated. Then, after the elapse of a certain period of time, the molds are opened to perform mold releasing, to thereby provide the urethane seat pad 102. Reference symbol 113 denotes carbon dioxide generated in a process of the foam growth.

Nowadays, an automobile seat has been increased in safety and comfortability, and accordingly, has been made higher in function, for example, an automobile seat with a built-in air bag or a sensing equipment. As a result, naturally, a shape of a urethane seat pad has rapidly become more complex (reduction in wall thickness, a bag-shaped form and the like), and along therewith, a degree of difficulty in molding has been increased.

In many cases, when urethane foam molding of the urethane seat pad 102 is performed, for the purposes of reinforcement (protecting a thin wall part) at the time of the molding, and absorbing gas generated inside the foaming molds at the time of the foam molding, and discharging the gas generated inside the foaming molds to the outside of the foaming molds, the seat-pad reinforcing cloth 104 being a fiber-based nonwoven fabric as illustrated in FIG. 26 and FIG. 27 is subjected to insert molding. As illustrated in FIG. 26, gas G generated inside the foaming molds passes through a narrow gap among the dedicated foaming molds 106 (lower mold), 108 (middle mold) and 110 (upper mold) to be discharged to the outside of the foaming molds. Hence, when the urethane raw liquid 112 is not subjected to uniform foaming, the gas G generated inside the foaming molds remains therein without being discharged to the outside of the foaming molds, which may cause a product defect of the urethane seat pad 102. Arrows of FIG. 27 indicate growth directions of foaming of the urethane raw liquid 112.

At the same time of complication of a product shape of the automobile seat, a level of requirement for the seat-pad reinforcing cloth has been made higher, and hence, a higher quality has been required.

In recent years, as illustrated in FIG. 28 (direction of the longitudinal section taken along the line A-A of FIG. 23) and FIG. 29 (direction of the transverse section taken along the line B-B of FIG. 24), the urethane seat pad 102 has, due to its structure, a thin wall part P which is present in a seat upper ridge line portion located substantially at an upper half of the seat, and which particularly includes a portion in the vicinity of a head of a person sitting on the seat, a portion in which an air bag is accommodated and the like. The thin wall part P has a thickness of about 10 mm. Accordingly, there is difficulty in manufacturing such that when particularly the seat upper ridge line portion and the like located at the upper half of the seat, which include the portion in the vicinity of the head and the portion in which the air bag is accommodated, are not subjected to fine and uniform foaming inside the foaming molds 106, 108 and 110 illustrated in FIG. 26 and FIG. 27, the urethane seat pad 102 as a urethane seat pad uniformly finished entirely cannot be achieved.

Further, the seat-pad reinforcing cloth 104 is set to the foaming molds 106, 108 and 110, and then the urethane foamed material is subjected to foaming. Hence, in order that the entirety of the urethane foamed material is subjected to fine and uniform foaming, it is required to attach and set, to the foaming molds, such a seat-pad reinforcing cloth that has no burr or crease and can be accurately attached to the foaming molds. Accordingly, a seat-pad reinforcing cloth with high accuracy which has no burr or crease and accurately fits the foaming molds has been required.

Hitherto, the following methods have been mainly used for manufacturing a seat-pad reinforcing cloth.

As a first method, there is a method of manufacturing a seat-pad reinforcing cloth by cutting out a reinforcing cloth material for each required member, and then three-dimensionally sewing the cut parts of the reinforcing cloth material corresponding to the respective required members, with a sewing machine or the like. In this method, an entire process of sewing is manual work (sewing work with a sewing machine), and hence, variation in quality is caused, and there are many problems also in terms of cost. Particularly, in simple sewing, the resultant seat-pad reinforcing cloth has low accuracy, and thus does not fit a foaming mold of a customer. Naturally, the sewing is required to be frequently redone, and hence, a period for production preparation is increased, resulting in three-dimensionally sewing with a complicated shape, thereby increasing cost.

As a second method, there is a method called “cold press molding”, which is a method of manufacturing a seat-pad reinforcing cloth by preparing male and female molding dies, and a material preheated in advance is shaped and molded by being cold-pressed. In a case of such a method, with the molding using the dies, quality in shape is improved, but the dies are of a press type, and hence, there are problems in terms of the time of delivery for manufacturing the dies (period for production preparation) and a complicated shape of the dies. Further, at the time of press molding, it is required to cut burrs called “selvages”, and accordingly, manual finishing work using scissors or machine cutting using a dedicated deburring die (jig for cutting) is required. Accordingly, it takes time also for performing the manual finishing work or preparing the deburring die, and hence the period for production preparation is increased, which has been a cause for inhibiting reduction in period.

Further, in recent years, in order to form a bag-shape being a difficult shape, a die having a special die structure is required, and hence, there has been a problem in that the period for production preparation is further increased.

As a third method, there is a method of manufacturing a seat-pad reinforcing cloth, as described in Patent Document 1, by preparing a dedicated molding mold (generally, aluminum casting mold) having air holes, fixing, to the dedicated molding mold, a roughly cut nonwoven fabric sheet having an outer shape substantially identical to a shape of the dedicated molding mold, covering the fixed nonwoven fabric sheet with a cover member (with a bag-shape) separately prepared, subjecting an inside of the bag-shaped cover member to heat-melting, and then to suction for shape retaining so that the nonwoven fabric sheet is three-dimensionally molded into a shape following the outer shape of the dedicated molding mold.

In the third method described above, quality in shape of the seat-pad reinforcing cloth after the molding is substantially at a satisfactory level. However, in the nonwoven fabric sheet serving as a material for the seat-pad reinforcing cloth, which has been put over the molding mold, shrinkage occurs due to heat generated at the time of the molding, and hence, although accuracy in shape is satisfactory, a position (accuracy) of an end portion of a product, which is regarded as next most important, is not stable. Accordingly, it is required to prepare a nonwoven fabric sheet serving as a material having a larger shape. However, with the use of such a nonwoven fabric sheet, in the end portion to have a desired shape, portions of the material protruding from the desired shape are generated, and eventually, it is required to subject such protruding burrs (also called “selvages”) to manual finishing with scissors in a later step, which has caused an increase in manufacturing cost.

Further, in the heat-melting step of the nonwoven fabric sheet serving as the material used at the time of the molding, and in the subsequent sucking step, a large-scale power device, such as a boiler serving as a heat source, and a vacuum pump for suction, is required, and as a result, a high energy cost is required. Those facts have become negative cost factors, such as an increase in man-hour and a higher manufacturing cost.

### PRIOR ART DOCUMENTS

### Patent Document

Patent Document 1: JP 4503538 B

### SUMMARY OF THE INVENTION

### Problems to be Solved by the Invention

The present invention has been made in view of the above-mentioned related art, and has an object to provide a manufacturing method and a manufacturing apparatus for a seat-pad reinforcing cloth, and a molding die, with which urethane foam grows uniformly even in a thinnest wall part of a urethane seat pad, and even when a seat-pad reinforcing cloth has a complicated shape, it is not required to prepare a larger material, and deburring work after molding is not required, thereby enabling eliminating manual work as much as possible.

### Means for Solving the Problems

In order to achieve the object described above, according to the present invention, there is provided a manufacturing method for a seat-pad reinforcing cloth which is to be used for a vehicular seat, the manufacturing method including a step of molding a seat upper ridge line portion of a seat-pad reinforcing cloth including: a step of putting a seat-pad reinforcing cloth material over a molding die for molding the seat-pad reinforcing cloth; an upper-end-portion heat-pressing molding step of performing heat-pressing molding on an upper end portion of the seat upper ridge line portion of the seat-pad reinforcing cloth material put over the molding die, from above by an upper-end-portion heat-pressing molding device, to generate creases in a periphery of a rear part of a portion of the seat-pad reinforcing cloth material, which has been subjected to the heat-pressing molding from above; a rear-portion heat-pressing molding step of performing heat-pressing molding by a rear-portion heat-pressing molding device on, together with the creases generated in the upper-end-portion heat-pressing molding step, a rear portion, which has not been subjected to the pressing molding by the upper-end-portion heat-pressing molding device, out of the seat upper ridge line portion of the seat-pad reinforcing cloth material put over the molding die; and a front-portion heat-pressing molding step of performing heat-pressing molding by a front-portion heat-pressing molding device on a front portion, which has not been subjected to the heat-pressing molding by the upper-end-portion heat-pressing molding device, out of the seat upper ridge line portion of the seat-pad reinforcing cloth material put over the molding die.

It is preferred that the manufacturing method further include, after the step of molding the seat upper ridge line portion: a step of performing heat-pressing molding on one side surface of the seat-pad reinforcing cloth material put over the molding die; a step of performing heat-pressing molding on another side surface of the seat-pad reinforcing cloth material put over the molding die; and a step of automatically demolding the seat-pad reinforcing cloth material put over the molding die, by a demolding mechanism.

It is preferred that the step of performing heat-pressing molding on the one side surface and/or the another side surface of the seat-pad reinforcing cloth material put over the molding die be sandwiching heat-pressing molding for performing heat-pressing molding by sandwiching the one side surface and/or the another side surface of the seat-pad reinforcing cloth material put over an air bag part of the molding die.

It is preferred that the manufacturing method further include, before the step of automatically demolding by the demolding mechanism, a cutting line forming step of forming a cutting line in a part of the one side surface or the another side surface of the seat-pad reinforcing cloth material put over the molding die, along a ridge line of the one side surface or the another side surface.

According to the present invention, there is provided a manufacturing apparatus for a seat-pad reinforcing cloth which is to be used for a vehicular seat, the manufacturing apparatus comprising: a molding die over which a seat-pad reinforcing cloth material is to be put in order to mold the seat-pad reinforcing cloth; an upper-end-portion heat-pressing molding device configured to perform heat-pressing molding from above on an upper end portion of the molding die, out of a seat upper ridge line portion of the seat-pad reinforcing cloth material put over the molding die, to generate creases in a periphery of a rear part of a portion of the seat-pad reinforcing cloth material, which has been subjected to the heat-pressing molding from above; a rear-portion heat-pressing molding device configured to perform pressing molding on, together with the creases generated due to the pressing molding by the upper-end-portion heat-pressing molding device, a rear portion, which has not been subjected to the pressing molding by the upper-end-portion heat-pressing molding device, out of the seat upper ridge line portion of the seat-pad reinforcing cloth material put over the molding die; and a front-portion heat-pressing molding device configured to perform heat-pressing molding on a front portion, which has not been subjected to the heat-pressing molding by the upper-end-portion heat-pressing molding device, out of the seat upper ridge line portion of the seat-pad reinforcing cloth material put over the molding die.

It is preferred that a heat-pressing portion of the upper-end-portion heat-pressing molding device have a shape following a shape of an upper end portion of the molding die, a heat-pressing portion of the rear-portion heat-pressing molding device have a shape following a shape of a rear portion of the molding die, and a heat-pressing portion of the front-portion heat-pressing molding device have a shape following a shape of a front portion of the molding die.

It is preferred that the seat upper ridge line portion of the seat-pad reinforcing cloth material put over the molding die be present on an upper side from a middle of the seat-pad reinforcing cloth material put over the molding die.

It is preferred that the manufacturing method further include: a one-side-surface heat-pressing molding device configured to perform heat-pressing molding on one side surface of the seat-pad reinforcing cloth material put over the molding die; another-side-surface heat-pressing molding device configured to perform heat-pressing molding on another side surface of the seat-pad reinforcing cloth material put over the molding die; and a demolding mechanism configured to automatically demold the seat-pad reinforcing cloth material put over the molding die.

It is preferred that the one-side-surface heat-pressing molding device and/or the another-side-surface heat-pressing molding device be a sandwiching heat-pressing molding device configured to perform heat-pressing molding by sandwiching the one side surface and/or the another side surface of the seat-pad reinforcing cloth material put over an air bag part of the molding die.

It is preferred that the demolding mechanism include a mechanism configured to perform pick-and-place on the seat-pad reinforcing cloth material put over the molding die.

It is preferred that the manufacturing apparatus further include a cutting line forming device configured to form a cutting line in a part of the one side surface or the another side surface of the seat-pad reinforcing cloth material put over the molding die, along a ridge line of the one side surface or the another side surface.

It is preferred that the cutting line forming device be a CO₂ laser marker.

According to the present invention, there is provided a molding die, which is to be used for the manufacturing apparatus for a seat-pad reinforcing cloth, the molding die comprising: a hollow die body which is made of a resin, and is shaped by a 3D printer; a suction port formed in the hollow die body; and a hook for pick provided on the hollow die body.

### Advantageous Effects of the Invention

The present invention achieves a significant effect of being capable of providing a manufacturing method and a manufacturing apparatus for a seat-pad reinforcing cloth, and a molding die, with which urethane foam grows uniformly even in a thinnest wall part of a urethane seat pad, and even when a seat-pad reinforcing cloth has a complicated shape, it is not required to prepare a larger material, and deburring work after molding is not required, thereby enabling eliminating manual work as much as possible.

### BRIEF DESCRIPTION OF THE DRAWINGS

FIG. 1 is an overall view for illustrating a manufacturing apparatus for a seat-pad reinforcing cloth according to one embodiment of the present invention.

FIG. 2 is an enlarged view of a main part of FIG. 1 for illustrating a state before a seat upper ridge line portion is molded.

FIG. 3 is a schematic view for schematically illustrating the state of FIG. 2.

FIG. 4 is a schematic view for illustrating a state in which a seat-pad reinforcing cloth material has been put over a molding die from the state of FIG. 3.

FIG. 5 is a main part enlarged view for illustrating a state in which heat-pressing molding is being performed from above by an upper-end-portion heat-pressing molding device.

FIG. 6 is a schematic view for schematically illustrating the state of FIG. 5.

FIG. 7 is an enlarged schematic view of FIG. 6.

FIG. 8 is a main part enlarged view for illustrating a state in which heat-pressing molding is being performed on a rear portion by a rear-portion heat-pressing molding device.

FIG. 9 is a schematic view for schematically illustrating the state of FIG. 8.

FIG. 10 is a main part enlarged view for illustrating a state in which heat-pressing molding is being performed on a front portion by a front-portion heat-pressing molding device.

FIG. 11 is a schematic view for schematically illustrating the state of FIG. 10.

FIG. 12 is a comparative schematic view for illustrating a state in which heat-pressing molding is being performed from above by the upper-end-portion heat-pressing molding device after heat-pressing molding has been performed on the rear portion by the rear-portion heat-pressing molding device.

FIG. 13 is a main part enlarged view for illustrating a state in which heat-pressing molding is being performed on one side surface by a one-side-surface heat-pressing molding device.

FIG. 14 is a main part enlarged view for illustrating a state in which heat-pressing molding is being performed by sandwiching another side surface by a sandwiching heat-pressing molding device/another-side-surface heat-pressing molding device, and in which the heat-pressing molding is being performed on an outer side of the another side surface.

FIG. 15 is a main part enlarged view for illustrating a state in which heat-pressing molding is being performed by sandwiching another side surface by the sandwiching heat-pressing molding device/another-side-surface heat-pressing molding device, and in which the heat-pressing molding is being performed on an inner side of the another side surface.

FIG. 16 is a main part enlarged view for illustrating the embodiment in which a cutting line forming device is provided.

FIG. 17 is a main part enlarged view for illustrating a urethane seat pad having a cutting line formed therein.

FIG. 18 are views for illustrating the urethane seat pad having the cutting line formed therein, FIG. 18(a) is a transverse sectional view, and FIG. 18(b) is an enlarged view of a main part of FIG. 18(a).

FIG. 19 is a main part enlarged view for illustrating a state in which the seat-pad reinforcing cloth material is separated from the molding die by a demolding mechanism after the molding.

FIG. 20 is a main part enlarged view for illustrating a state in which the seat-pad reinforcing cloth material is picked up from the molding die and placed by the demolding mechanism after the molding.

FIG. 21 is a main part enlarged view of the state of the separating from the molding die as illustrated in FIG. 19, when viewed from another angle.

FIG. 22 is a main part enlarged view for schematically illustrating the state in which the seat-pad reinforcing cloth material is picked up from the molding die and placed by the demolding mechanism after the molding.

FIG. 23 is a perspective view of a urethane seat pad to be used for an automobile seat, when viewed from a front surface side thereof.

FIG. 24 is a perspective view of the urethane seat pad to be used for an automobile seat, when viewed from a rear surface side thereof.

FIG. 25 is a view for illustrating an example of a shape of the seat-pad reinforcing cloth material.

FIG. 26 is a longitudinal sectional view for illustrating a state in which urethane foam molding of the urethane seat pad is performed in a dedicated mold.

FIG. 27 is a partially enlarged view of a transverse section for illustrating the state in which the urethane foam molding of the urethane seat pad is performed in the dedicated mold.

FIG. 28 is a longitudinal sectional view of the urethane seat pad.

FIG. 29 is a transverse sectional view of the urethane seat pad.

### DESCRIPTION OF EMBODIMENTS

The embodiment of the present invention is described below. However, the embodiment is described by way of example, and needless to say, the present invention can be modified in various ways unless departing from the technical idea of the present invention. The same elements are denoted by the same reference symbols.

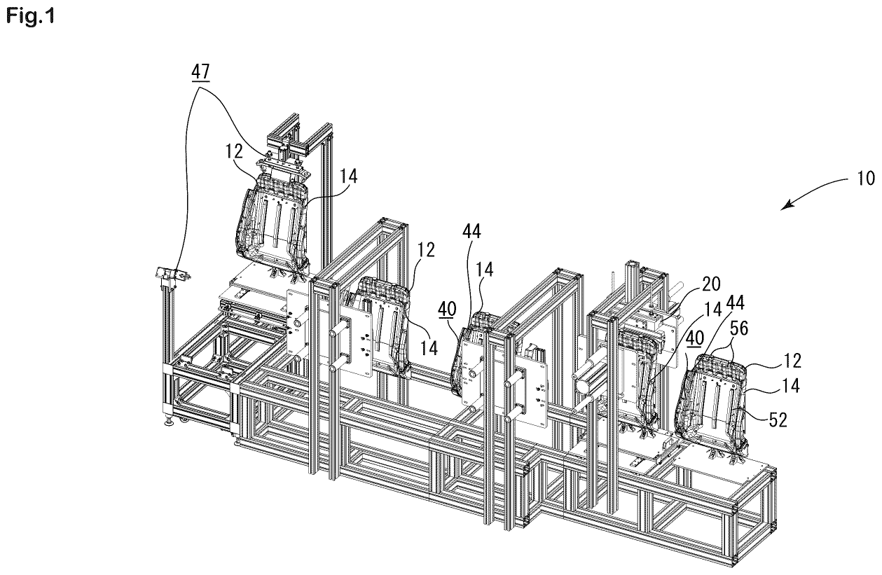

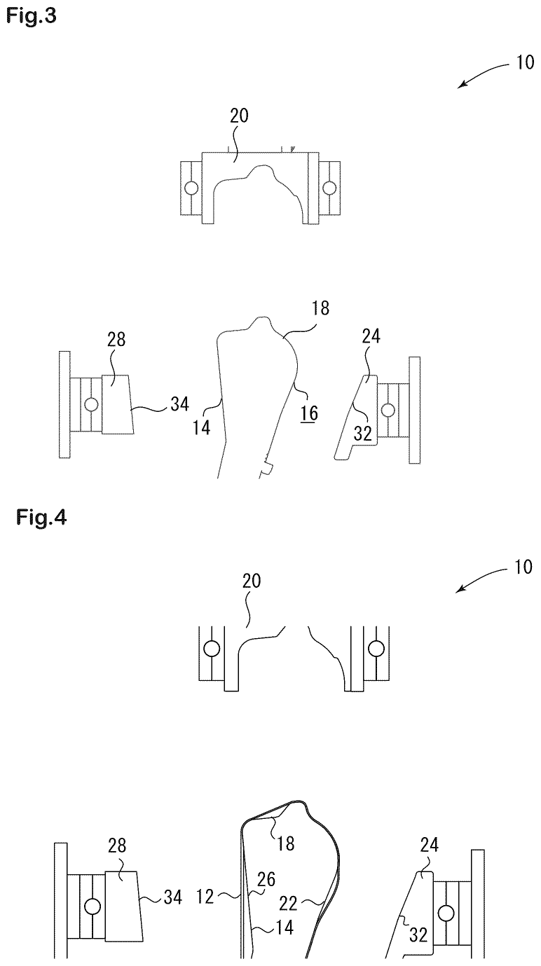

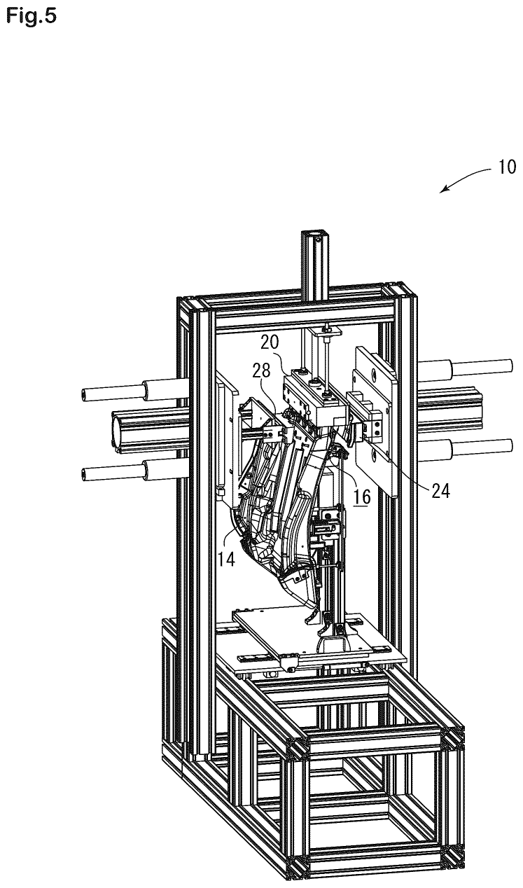

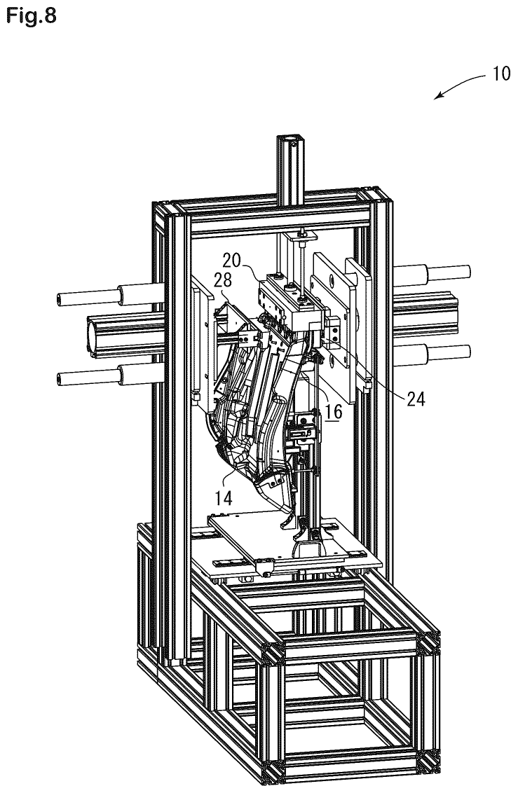

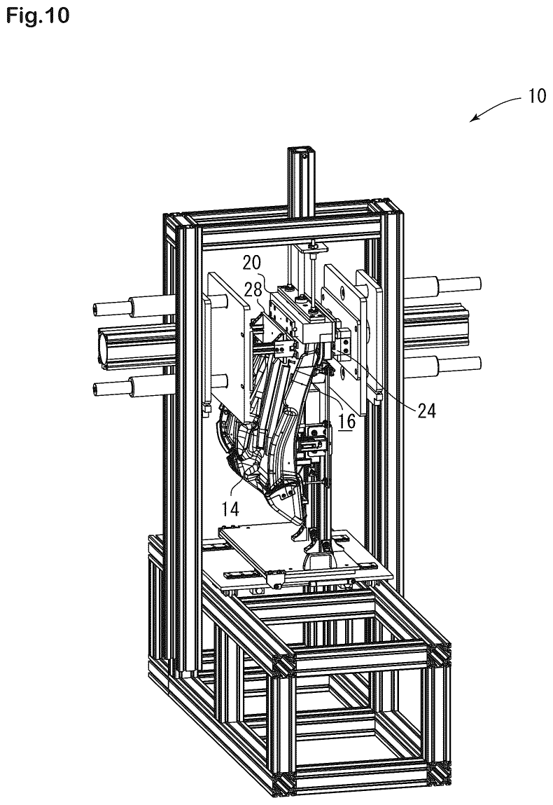

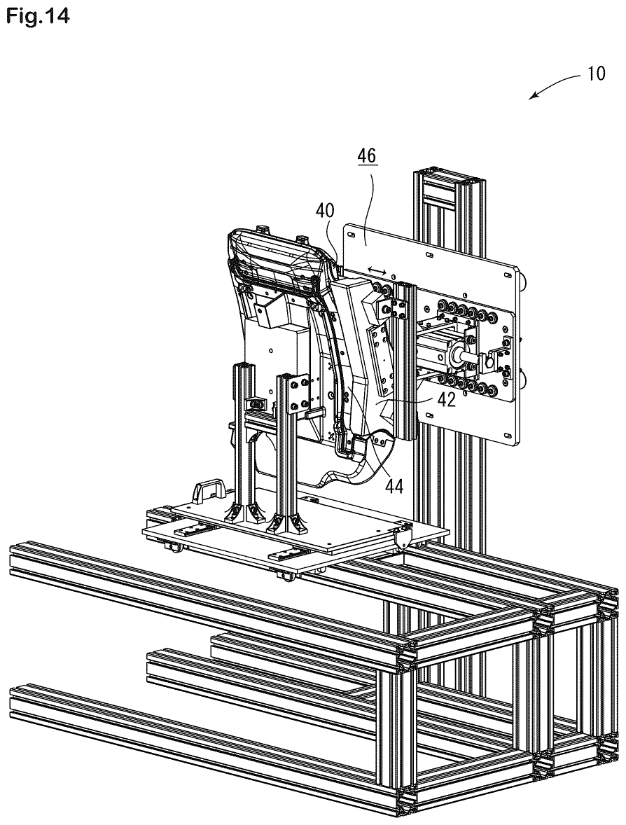

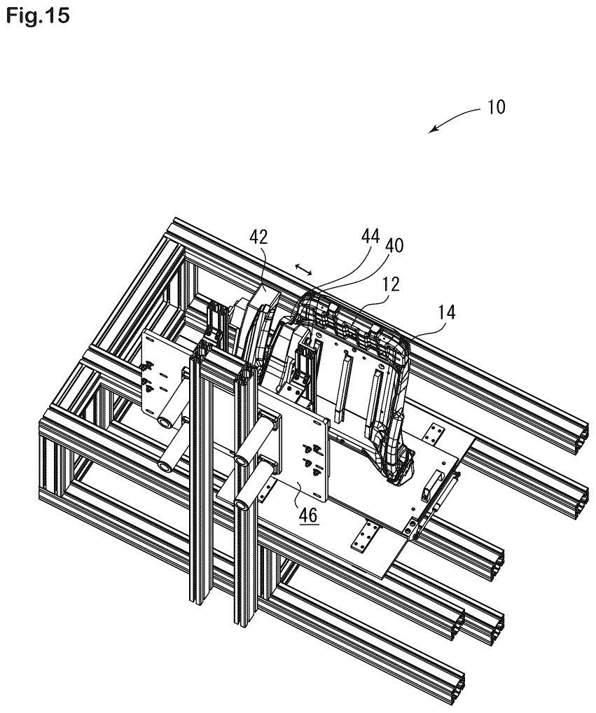

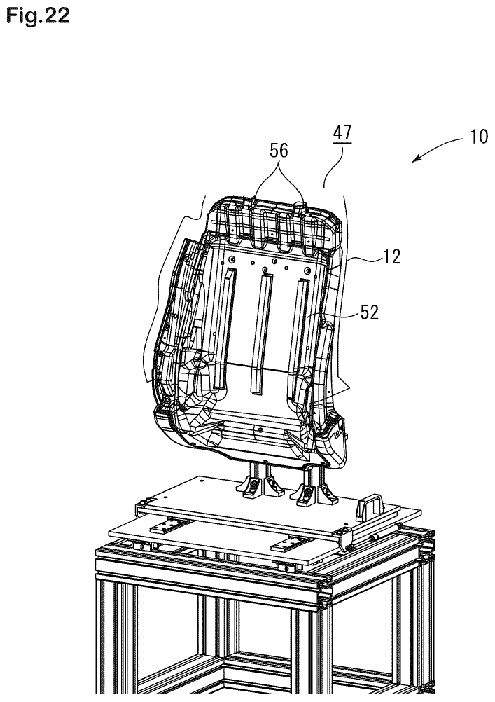

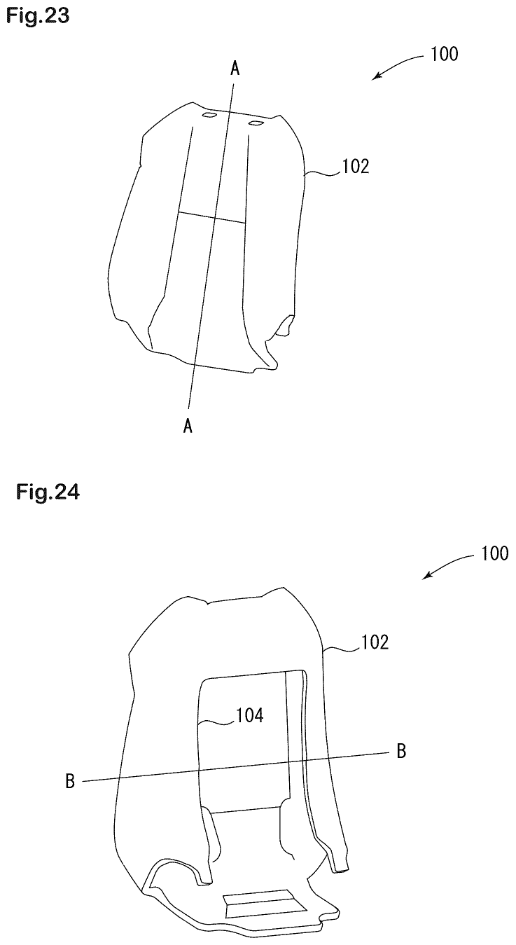

In FIG. 1 to FIG. 22, reference symbol 10 denotes a manufacturing apparatus for a seat-pad reinforcing cloth according to the present invention. A manufacturing apparatus 10 for a seat-pad reinforcing cloth is a manufacturing apparatus for a seat-pad reinforcing cloth 104 which is to be used for a vehicular seat. The manufacturing apparatus 10 includes: a molding die 14 over which a seat-pad reinforcing cloth material 12 is to be put in order to mold the seat-pad reinforcing cloth 104; an upper-end-portion heat-pressing molding device 20 configured to perform heat-pressing molding from above on an upper end portion 18 of the molding die 14, out of a seat upper ridge line portion 16 of the seat-pad reinforcing cloth material 12 put over the molding die 14, to generate creases 19 in a periphery of a rear part of a portion of the seat-pad reinforcing cloth material 12, which has been subjected to the heat-pressing molding from above; a rear-portion heat-pressing molding device 24 configured to perform pressing molding on, together with the creases 19 generated due to the pressing molding by the upper-end-portion heat-pressing molding device 20, a rear portion 22, which has not been subjected to the pressing molding by the upper-end-portion heat-pressing molding device 20, out of the seat upper ridge line portion 16 of the seat-pad reinforcing cloth material 12 put over the molding die 14; and a front-portion heat-pressing molding device 28 configured to perform heat-pressing molding on a front portion 26, which has not been subjected to the heat-pressing molding by the upper-end-portion heat-pressing molding device 20, out of the seat upper ridge line portion 16 of the seat-pad reinforcing cloth material 12 put over the molding die 14.

In the illustrated example, an example is given of a case in which the molding die 14 is a molding die for a seat back part. The manufacturing apparatus and a manufacturing method for a seat-pad reinforcing cloth according to the present invention can be suitably used for a seat-pad reinforcing cloth for the seat back part. Further, it is preferred that a molding die according to the present invention to be described later be also a molding die for the seat back part.

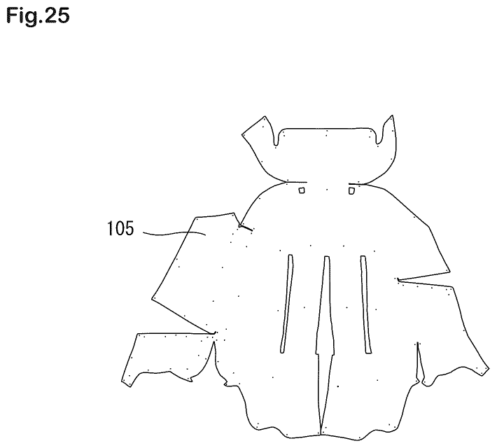

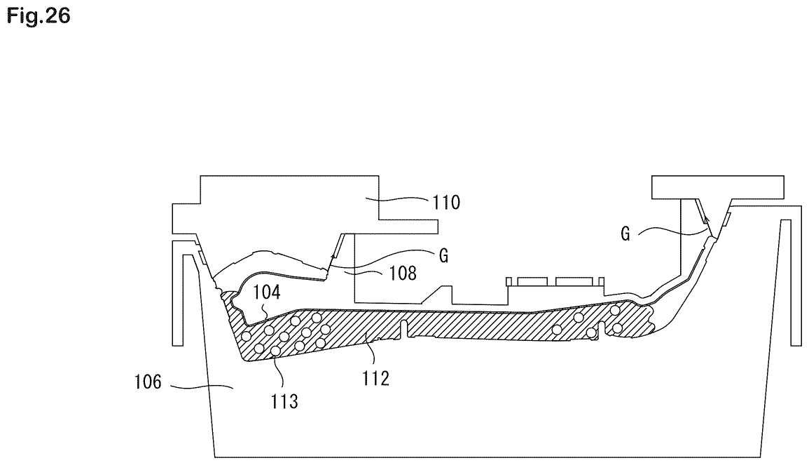

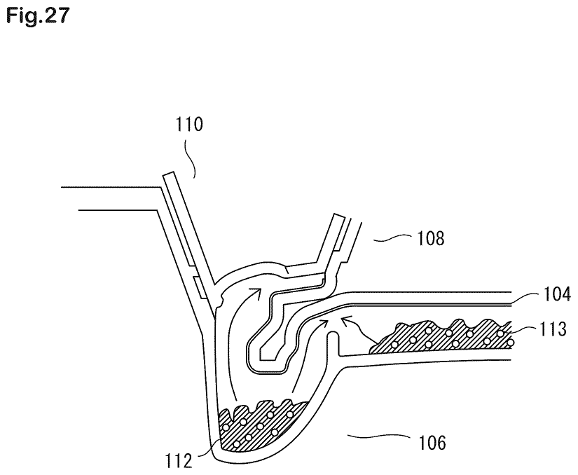

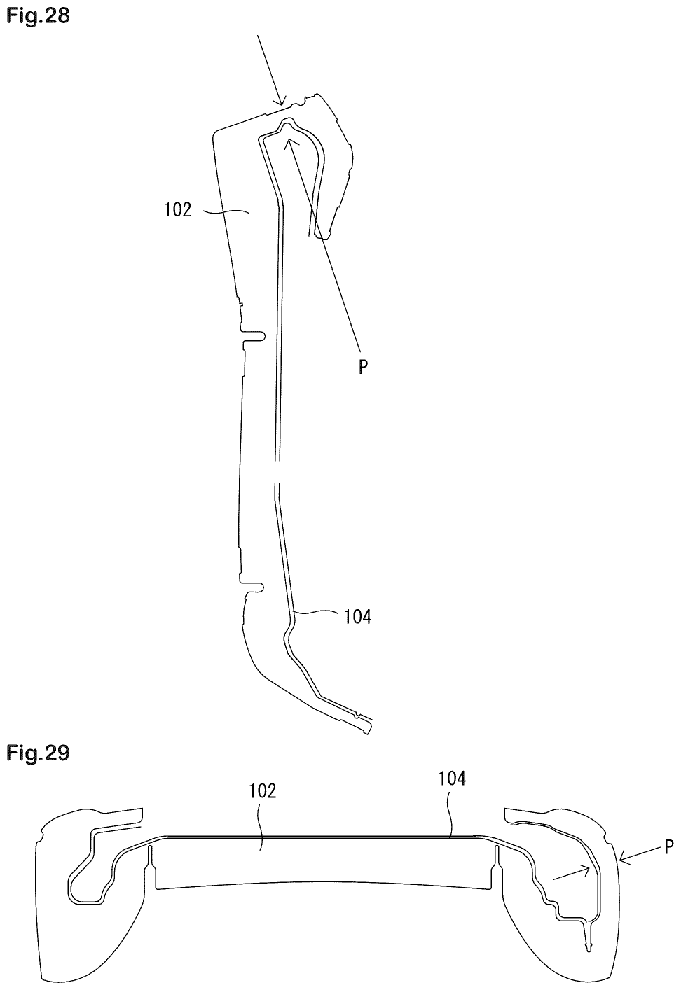

A material to be used as a seat-pad reinforcing cloth material 12 is not particularly limited as long as the material has permeability to the air, and for example, a nonwoven fabric or felt can be used. Further, a sheet to be used for molding a seat-pad reinforcing cloth as disclosed in Patent Document 1, for example, a sheet in which a granular thermoplastic resin is contained in a nonwoven fabric, a sheet in which low melting point fibers and high melting point fibers are mixed in a nonwoven fabric sheet, a sheet in which a granular thermoplastic resin is contained in flocculent felt or fulled felt, or flocculent felt or fulled felt obtained by mixing low melting point fibers and high melting point fibers, can be suitably used. As the seat-pad reinforcing cloth material 12, a seat-pad reinforcing cloth material 105 having a shape as illustrated in FIG. 25 can be used. However, in a case of the present invention, a larger shape as employed in the related art is not required, and thus, the seat-pad reinforcing cloth material 12 designed to have a more optimal shape corresponding to the molding die 14 is used. In the drawings, for convenience, the seat-pad reinforcing cloth material 12 may be drawn so as to be transparent (for example, FIG. 1).

Further, it is preferred that the upper-end-portion heat-pressing molding device 20, the rear-portion heat-pressing molding device 24 and the front-portion heat-pressing molding device 28 be heating attachments (heat-pressing tools) for performing heat-pressing on the respective portions. For example, an electrothermal heating attachment having a structure of being heated by electricity as in an electric iron is applicable. As described above, the use of the heating attachments such as the upper-end-portion heat-pressing molding device 20, the rear-portion heat-pressing molding device 24 and the front-portion heat-pressing molding device 28 enables performing local heat-pressing. Accordingly, shrinkage of the material is not caused, and also a larger material is not used. As a result, there is an advantage in that reduction in man-hour, amount of the material to be used, and energy required at the time of molding is achieved, resulting in reduction in cost.

Further, when water (water mist) is contained in advance in the seat-pad reinforcing cloth material 12, at a point of time when the seat-pad reinforcing cloth material 12 is subjected to heat-pressing by the rear-portion heat-pressing molding device 24 and the front-portion heat-pressing molding device 28, the contained water is vaporized to instantaneously spread inside the seat-pad reinforcing cloth material 12 so that die-pressing molding can be more suitably performed. Thus, it is preferred that the manufacturing method for a seat-pad reinforcing cloth according to the present invention to be described later include a step of causing the seat-pad reinforcing cloth material 12 to contain water in advance.

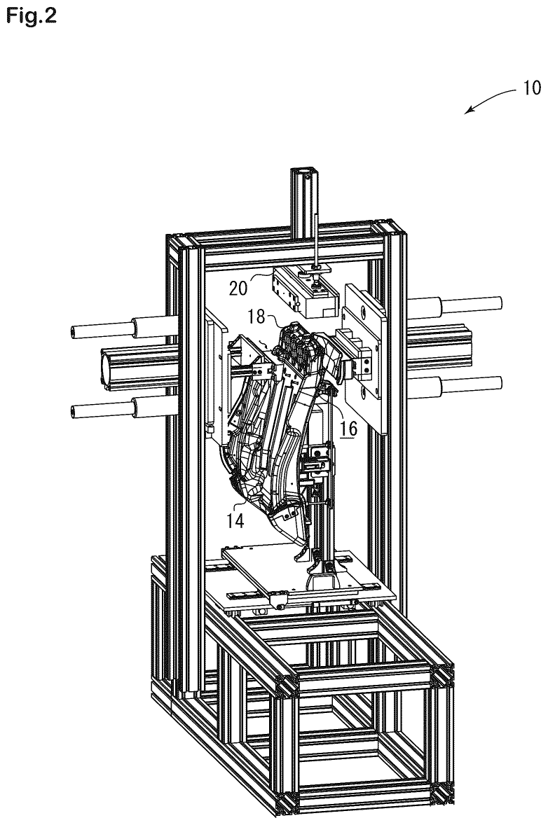

Further, as clearly illustrated in, for example, FIG. 2 to FIG. 11, a heat-pressing portion 30 of the upper-end-portion heat-pressing molding device 20 has a shape following a shape of the upper end portion 18 of the molding die 14, a heat-pressing portion 32 of the rear-portion heat-pressing molding device 24 has a shape following a shape of the rear portion 22 of the molding die 14, and a heat-pressing portion 34 of the front-portion heat-pressing molding device 28 has a shape following a shape of the front portion 26 of the molding die 14.

In the illustrated example, the seat upper ridge line portion 16 of the seat-pad reinforcing cloth material 12 put over the molding die 14 is present on an upper side from a middle of the seat-pad reinforcing cloth material 12 put over the molding die 14. That is, a portion, which corresponds to an upper half from the line B-B of the urethane seat pad 102 as illustrated in FIG. 24, of the seat-pad reinforcing cloth material 12 put over the molding die 14 corresponds to the seat upper ridge line portion 16.

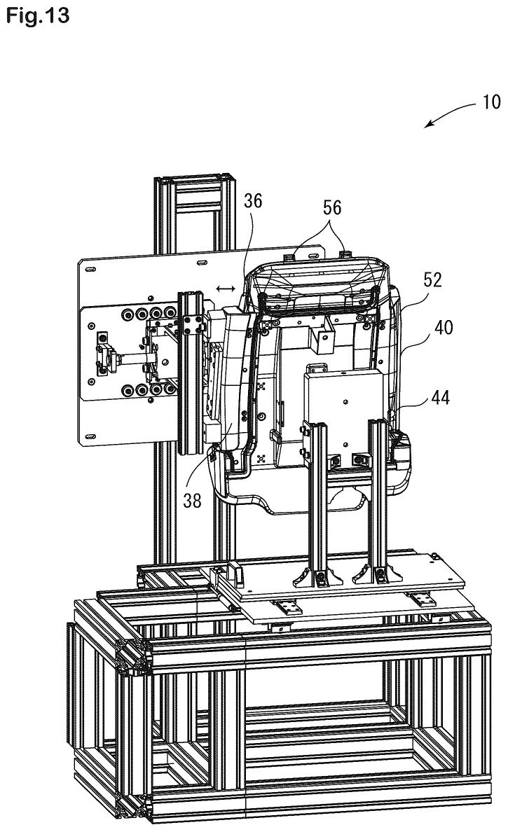

Further, as clearly illustrated in FIG. 1 and FIG. 13 to FIG. 15, the manufacturing apparatus 10 for a seat-pad reinforcing cloth includes: a one-side-surface heat-pressing molding device 38 configured to perform heat-pressing molding on one side surface 36 of the seat-pad reinforcing cloth material 12 put over the molding die 14; and an another-side-surface heat-pressing molding device 42 configured to perform heat-pressing molding on another side surface 40 of the seat-pad reinforcing cloth material 12 put over the molding die 14. As indicated by arrowed lines of FIG. 13 to FIG. 15, both of the one-side-surface heat-pressing molding device 38 and the another-side-surface heat-pressing molding device 42 are slidable so as to be able to come into contact with and separate from the molding die 14.

It is preferred that the one-side-surface heat-pressing molding device 38 and/or the another-side-surface heat-pressing molding device 42 serve as a sandwiching heat-pressing molding device 46 for performing heat-pressing molding by sandwiching the one side surface 36 and/or the another side surface 40 of the seat-pad reinforcing cloth material 12 put over an air bag part 44 of the molding die 14. In the illustrated example, an example is given of a case in which the another-side-surface heat-pressing molding device 42 serves as the sandwiching heat-pressing molding device 46 for performing heat-pressing molding by sandwiching the another side surface 40 of the seat-pad reinforcing cloth material 12 put over the air bag part 44 of the molding die 14. The another side surface 40 protrudes further than the one side surface 36 due to the presence of the air bag part 44, and accordingly, it is required to perform heat-pressing molding by sandwiching the another side surface 40.

In some cases, an automobile seat has air bags provided on both sides (that is, one side surface and another side surface) of the seat back part, respectively. In this case, it is preferred that the one-side-surface heat-pressing molding device 38 and the another-side-surface heat-pressing molding device 42 serve as sandwiching heat-pressing molding devices for performing heat-pressing molding by sandwiching air bag parts provided respectively on both sides, that is, on the one side surface side and the another side surface side of the seat-pad reinforcing cloth material 12 put over the air bag parts of the molding die. In a case of an automobile seat having no air bag provided on both sides of the seat back part, it is not required that the one-side-surface heat-pressing molding device 38 and/or the another-side-surface heat-pressing molding device 42 serve as sandwiching heat-pressing molding devices for performing heat-pressing molding by sandwiching the one side surface and/or the another side surface.

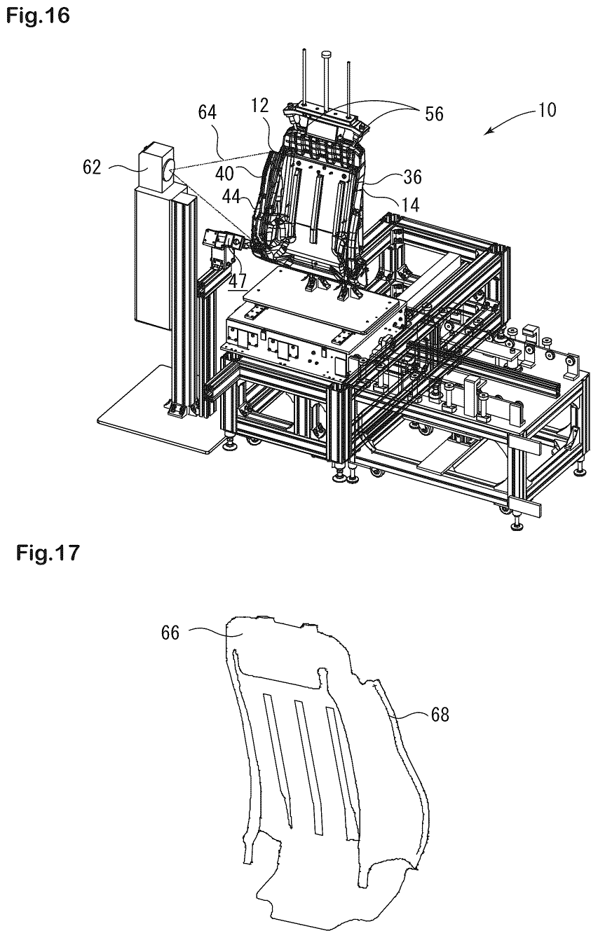

In FIG. 16, illustration is given of the embodiment in which the manufacturing apparatus 10 for a seat-pad reinforcing cloth is provided with a cutting line forming device 62 for forming a cutting line in a part of the one side surface 36 or the another side surface 40 of the seat-pad reinforcing cloth material 12 put over the molding die 14, along a ridge line of the one side surface 36 or the another side surface 40. The cutting line forming device 62 is provided to a demolding mechanism 47 of the manufacturing apparatus 10 for a seat-pad reinforcing cloth. In the illustrated example, an example is given of a case in which a CO₂ laser marker is arranged as the cutting line forming device 62. In FIG. 16, reference symbol 64 denotes a laser beam. A commercially available CO₂ laser marker can be used as the CO₂ laser marker.

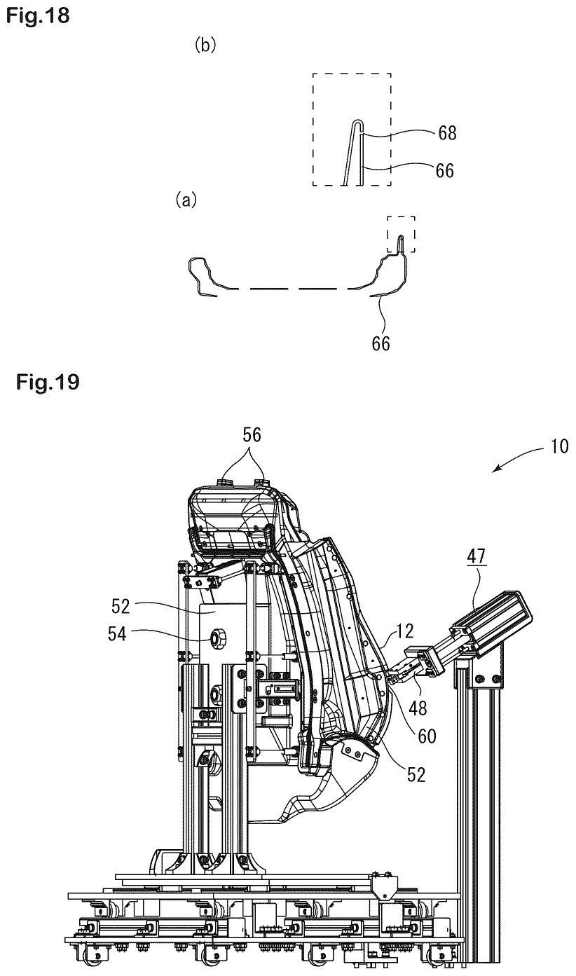

As illustrated in FIG. 17 and FIG. 18, a cutting line 68 is formed by the cutting line forming device 62, thereby achieving an effect of allowing an air bag to easily jump out from the air bag part 44. Hence, the cutting line 68 is formed by the cutting line forming device 62 in a part of the one side surface 36 or the another side surface 40 (in the illustrated example, the another side surface 40) on a side, on which the air bag part 44 is present, of the seat-pad reinforcing cloth material 12 put over the molding die 14, along the ridge line of the one side surface 36 or the another side surface 40 (in the illustrated example, the another side surface 40). The cutting line 68 is formed as a dotted cutting line, and is processed so as to allow the air bag to easily jump out. In this manner, the seat-pad reinforcing cloth material 12 has an easy opening portion which has been processed so as to allow the air bag to easily jump out.

FIG. 18(a) is a transverse sectional view of a urethane seat pad 66 having the cutting line 68 formed therein. FIG. 18(b) is a main part enlarged view of FIG. 18(a). As clearly illustrated in FIG. 18(a) and FIG. 18(b), the cutting line 68 is formed as a dotted cutting line as described above. Accordingly, in the urethane seat pad 66, the cutting line 68 serves as the easy opening portion which has been processed so as to allow the air bag to easily jump out.

In addition, as clearly illustrated in FIG. 19 to FIG. 22, the manufacturing apparatus 10 for a seat-pad reinforcing cloth is provided with the demolding mechanism 47 configured to automatically demold the seat-pad reinforcing cloth material 12 put over the molding die 14.

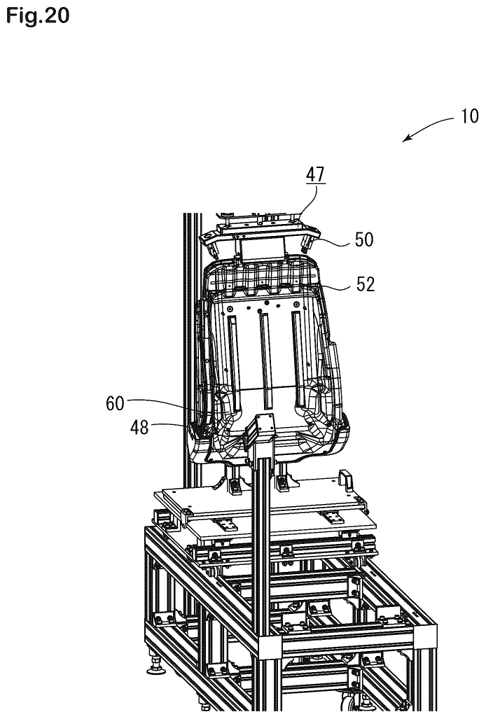

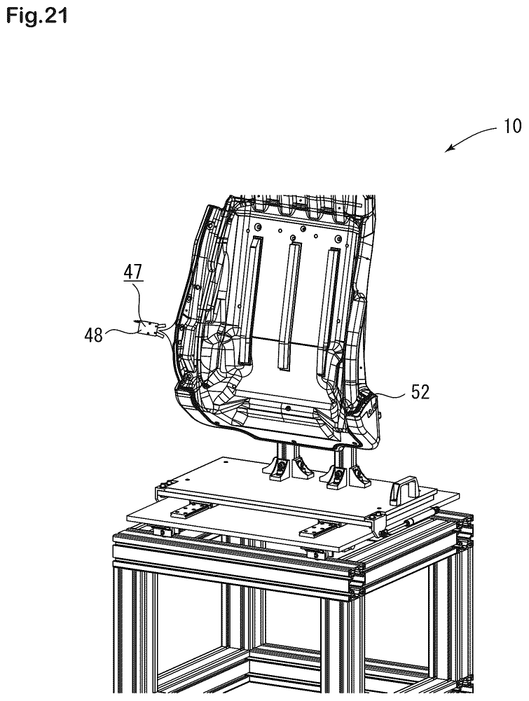

The demolding mechanism 47 includes a mechanism configured to perform pick-and-place on the seat-pad reinforcing cloth material 12 put over the molding die 14. More specifically, the demolding mechanism 47 includes a separating arm part 48 for separating the seat-pad reinforcing cloth material 12 from the molding die 14, and a pickup part 50 for picking up and then transferring the seat-pad reinforcing cloth material 12 separated from the molding die 14 (see FIG. 20).

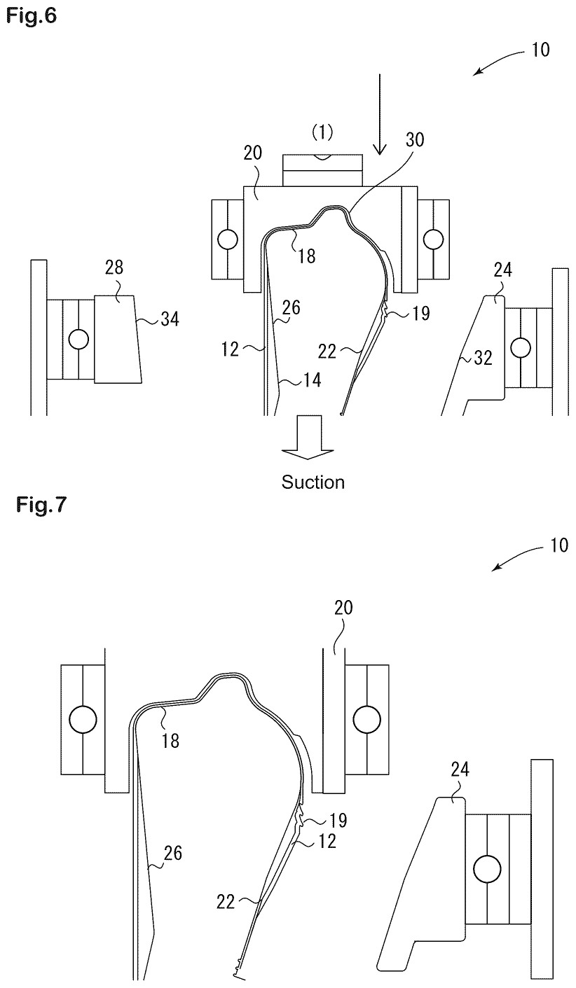

The molding die 14 is a molding die according to one embodiment of the present invention. The molding die 14 includes a hollow die body 52, a suction port 54 and a hook part for pick 60. The hollow die body 52 is made of a resin and is shaped by a 3D printer. The suction port 54 is formed in the hollow die body 52. The hook part for pick 60 is provided on the hollow die body 52. The hollow die body 52 has a plurality of holes. As shown in, for example, FIG. 6, air is sucked from the suction port 54 so that the seat-pad reinforcing cloth material 12 is cooled immediately after being heated. Further, it is preferred that a heat-resistant resin be used for a portion of the molding die 14 to which heat is to be applied by the heating attachment (heat-pressing tool) being the heat-pressing molding device, and a general-purpose inexpensive resin (resin with no heat resistance) be used for a general portion of the molding die 14 to which no heat is to be applied thereby.

Now, description is given of a manufacturing method for a seat-pad reinforcing cloth according to the present invention using the manufacturing apparatus 10 for a seat-pad reinforcing cloth.

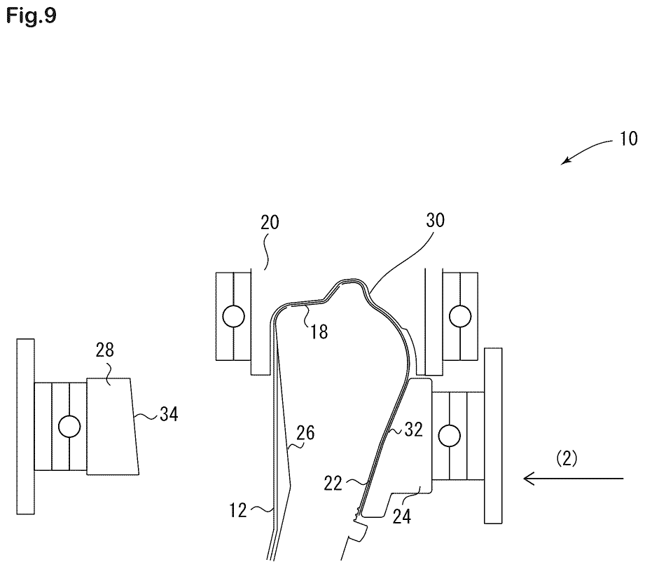

The manufacturing method for a seat-pad reinforcing cloth according to the present invention includes a step of molding a seat upper ridge line portion 16 of a seat-pad reinforcing cloth material 12 including: a step of putting a seat-pad reinforcing cloth material 12 over a molding die 14 for molding the seat-pad reinforcing cloth; an upper-end-portion heat-pressing molding step ((1) of FIG. 6) of performing heat-pressing molding on an upper end portion 18 of the seat upper ridge line portion 16 of the seat-pad reinforcing cloth material 12 put over the molding die 14, from above by an upper-end-portion heat-pressing molding device 20, to generate creases 19 in a periphery of a rear portion 22 of a part of the seat-pad reinforcing cloth material 12, which has been subjected to the heat-pressing molding from above; a rear-portion heat-pressing molding step ((2) of FIG. 9) of performing heat-pressing molding by a rear-portion heat-pressing molding device 24 on, together with the creases 19 generated in the upper-end-portion heat-pressing molding step, a rear portion 22, which has not been subjected to the heat-pressing molding by the upper-end-portion heat-pressing molding device 20, out of the seat upper ridge line portion 16 of the seat-pad reinforcing cloth material 12 put over the molding die 14; and a front-portion heat-pressing molding step ((3) of FIG. 11) of performing heat-pressing molding by a front-portion heat-pressing molding device 28 on a front portion 26, which has not been subjected to the heat-pressing molding by the upper-end-portion heat-pressing molding device 20, out of the seat upper ridge line portion 16 of the seat-pad reinforcing cloth material 12 put over the molding die 14.

After putting the seat-pad reinforcing cloth material 12 over the molding die 14 to be used for molding the seat-pad reinforcing cloth, water mist is applied to the seat-pad reinforcing cloth material 12.

The seat-pad reinforcing cloth material 12 which is exactly the right size to most fit the molding die 14 having substantially the same shape as that of the urethane seat pad is put over the molding die 14, and only portions required to be molded is subjected to local heat-molding by the heat-pressing molding device being the heating attachment. In such a manner, no large thermal shrinkage occurs in the seat-pad reinforcing cloth material 12, and no selvage is generated in the molded seat-pad reinforcing cloth. As a result, cutting off selvages after the molding is not required, thereby enabling significant reduction in cost. Loss of a material for the seat-pad reinforcing cloth material 12 can be also reduced. It is preferred that the seat-pad reinforcing cloth material 12 be a sheet in which a granular thermoplastic resin is contained in a nonwoven fabric, or a nonwoven fabric sheet in which low melting point fibers and high melting point fibers are mixed, as disclosed in Patent Document 1 as described above. With the use of such sheets, molding of the seat-pad reinforcing cloth is made easier, and in addition, the seat-pad reinforcing cloth has moderate rigidity after the molding, and hence a shape thereof is satisfactorily maintained.

Further, when putting the seat-pad reinforcing cloth material 12 over the molding die 14, which is to be used for molding the seat-pad reinforcing cloth, and fixing the seat-pad reinforcing cloth material 12 to the molding die 14, it is preferred that the seat-pad reinforcing cloth material 12 be fixed to the molding die 14 by magnets. Moreover, when a method of fixing the seat-pad reinforcing cloth material 12 to the molding die 14 while performing suction from the suction port 54 is employed in combination, the seat-pad reinforcing cloth material 12 can be fixed under a satisfactory state with no positional displacement.

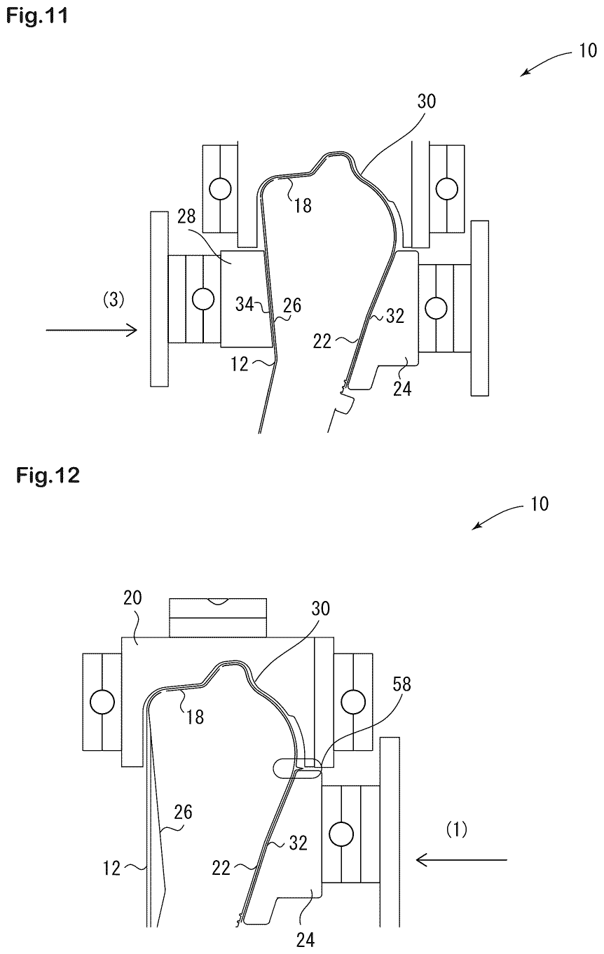

For comparison, FIG. 12 shows a state in which after heat-pressing molding ((1) of FIG. 12) has been first performed on the rear portion 22 by the rear-portion heat-pressing molding device 24, heat-pressing molding is being performed on the upper end portion 18 of the seat upper ridge line portion 16 of the seat-pad reinforcing cloth material 12 from above by the upper-end-portion heat-pressing molding device 20. As described above, when after heat-pressing molding has been first performed on the rear portion 22 by the rear-portion heat-pressing molding device 24, heat-pressing molding is performed on the upper end portion 18 of the seat upper ridge line portion 16 of the seat-pad reinforcing cloth material 12 from above by the upper-end-portion heat-pressing molding device 20, a crushed portion 58 occurs in the seat-pad reinforcing cloth material 12. Such a crushed portion 58 causes burrs, resulting in a defective product. Thus, as described above, it is important that after the upper-end-portion heat-pressing molding step ((1) of FIG. 6), the rear-portion heat-pressing molding step ((2) of FIG. 9) be performed, and then, the front-portion heat-pressing molding step ((3) of FIG. 11) be performed.

Further, it is preferred that the manufacturing method for a seat-pad reinforcing cloth according to the present invention further include, after the step of molding the seat upper ridge line portion 16: a step of performing heat-pressing molding on one side surface 36 of the seat-pad reinforcing cloth material 12 put over the molding die 14; a step of performing heat-pressing molding on another side surface 40 of the seat-pad reinforcing cloth material 12 put over the molding die 14; and a step of automatically demolding the seat-pad reinforcing cloth material 12 put over the molding die 14, by a demolding mechanism 47.

Further, it is preferred that the manufacturing method for a seat-pad reinforcing cloth material include, before the step of automatically demolding by the demolding mechanism 47, a cutting line forming step of forming the cutting line 68 by the cutting line forming device 62 in a part of the one side surface 36 or the another side surface 40 (in the illustrated example, the another side surface 40) of the seat-pad reinforcing cloth material 12 put over the molding die 14, along the ridge line of the one side surface 36 or the another side surface 40 (in the illustrated example, the another side surface 40). As illustrated in FIG. 17 and FIG. 18, the formation of the cutting line 68 achieves an effect of allowing an air bag to easily jump out from the air bag part 44.

When the molded product (seat-pad reinforcing cloth) is to be demolded from the molding die 14, as illustrated in FIG. 19, the molded product is separated from the molding die 14 by gripping the hook part for pick 60 installed in advance on the molding die 14, with a claw of the separating arm part 48 of the demolding mechanism 47. Then, claws of the pickup part 50 are lowered to hook parts 56 installed on a shoulder part of the molding die 14, and further pick up the molded product by gripping the hook parts 56. In this way, demolding of a product which has been hitherto performed manually can be automatized. The hook parts 56 also serve as hooks for pick, and hence, the concept of hooks for pick provided to the molding die 14 according to the present invention includes both the hook part for pick 60 and the hook parts 56.

Further, the step of performing heat-pressing molding on the one side surface 36 and/or the another side surface 40 of the seat-pad reinforcing cloth material 12 put over the molding die 14 is sandwiching heat-pressing molding for performing heat-pressing molding by sandwiching the one side surface 36 and/or the another side surface 40 of the seat-pad reinforcing cloth material 12 put over the air bag part 44 of the molding die 14.

In the illustrated example, an example is given of a case in which the another-side-surface heat-pressing molding device 42 serves as the sandwiching heat-pressing molding device 46 for performing heat-pressing molding by sandwiching the another side surface 40 of the seat-pad reinforcing cloth material 12 put over the air bag part 44 of the molding die 14. The another side surface 40 protrudes further than the one side surface 36 due to the presence of the air bag part 44, and accordingly, it is required to perform heat-pressing molding by sandwiching the another side surface 40.

The manufacturing method for a seat-pad reinforcing cloth according to the present invention has the following features.

1. Provided is a method in which an entire surface of the seat-pad reinforcing cloth material is not subjected to heat at the time of molding the seat-pad reinforcing cloth.

As in the method described in Patent Document 1, when the entire surface of the seat-pad reinforcing cloth material is subjected to heat at the time of the molding, “thermal shrinkage” occurs in the seat-pad reinforcing cloth material. Accordingly, hitherto, in anticipation of an amount corresponding to the thermal shrinkage, the seat-pad reinforcing cloth material is prepared by being roughly cut out in advance by a dimension larger than a required dimension. When the cut seat-pad reinforcing cloth material is set by being put over the molding die, for example, variation in setting work of putting the cut seat-pad reinforcing cloth material over the molding die or variation in molding conditions may cause portions of the cut seat-pad reinforcing cloth material to protrude out of a normal range of the shape, and such protrusion becomes selvages (burrs) after the molding.

Accordingly, it is required to perform “burr cutting” on such unnecessary portions (selvages, burrs) after the molding.

Hence, in the present invention, the entire surface of the seat-pad reinforcing cloth material is not subjected to “heat” at the time of the molding. Only portions required for use are subjected to partial shaping (molding) with use of the heating attachments (heat-pressing tools) being the heat-pressing molding devices, and other portions are not subjected to molding.

Further, according to the present invention, a large-scale power source (heat source boiler) and a motive power for sucking (for example, vacuum pump) are not required, thereby achieving energy saving.

In addition, in order to shorten a molding time, when water (water mist) is contained in advance in portions of the seat-pad reinforcing cloth material (preferably, the seat-pad reinforcing cloth material as described in Patent Document 1) to be subjected to heat-pressing, at a point of time when the portions are pressed by the heating attachments (heat-pressing tools), the contained water is vaporized to instantaneously spread inside the material so that die-pressing molding can be performed.

In such a manner, shrinkage of the seat-pad reinforcing cloth material is not caused, and also a larger material is not required to be used. Accordingly, reduction in man-hour and amount of the material to be used can be achieved. Moreover, reduction in energy required at the time of molding can be achieved, resulting in reduction in cost.

2. The shape of the seat-pad reinforcing cloth material before molding of the seat-pad reinforcing cloth has been minimized.

With the entire surface of the seat-pad reinforcing cloth material being not subjected to heat-molding, designing the shape of the seat-pad reinforcing cloth material based on an empirical rule, such as anticipating thermal shrinkage to occur in each portion of the material, which has been hitherto performed, is not required. Accordingly, in the present invention, it is only required that the shape of the seat-pad reinforcing cloth material fit just right a designed shape of a product after molding.

In this manner, it is possible to perform development and design of a material pattern for the seat-pad reinforcing cloth directly from product 3D data by a commercially available computer aided design (CAD).

3. A resin die (die shaped by a 3D printer) can be used as the molding die for molding the seat-pad reinforcing cloth, without using a metal die.

Discharging heat generated at the time of molding has enabled changing a material for a die used as a molding die from the related-art metal die (aluminum casting mold) having heat-resistance to a die made of a resin. Hence, also for a method of manufacturing a die, it has become possible to substitute a resin die shaped by a 3D printer, which can be directly manufactured from die CAD data. Accordingly, significant reduction in lead time and reduction in weight of the die have been achieved. A hybrid die structure has been employed in which a heat-resistant resin is used for a portion of the die to which heat is to be applied by the heating attachment (heat-pressing tool) being the heat-pressing molding device, and a general-purpose inexpensive resin (resin with no heat resistance) is used for a general portion of the die to which no heat is to be applied thereby, so that resins of different materials are properly and differently used in accordance with the respective materials.

4. With 3D printer shaping being employed, a molding die is formed to be hollow, thereby achieving improvement of a cycle rate.

Further, with the use of a die shaped by a 3D printer, a die having a hollow structure can be easily manufactured, and heat generated during molding can be discharged (exhausted) to the outside of the die through a suction port formed therein in advance, with a hollow portion of the die being used as an exhaust heat flow passage.

In this manner, work heat accumulated during molding can be rapidly discharged. As a result, a molding cycle can be significantly shortened.

Further, even in a case of a shaped object having a structure of being moved by some components being combined with each other, which is an advantage of a 3D printer shaping technology, integral molding can be performed. Hence, some required mechanism structures are incorporated into such a molding die to perform integral shaping. Accordingly, final assembly work is not required, and operation confirmation can be immediately performed. As a result, a period required for producing prototypes can be shortened. For example, integration of a flow passage for discharging heat or a suction port with the molding die, or integration of die mechanism components for automatic demolding with the molding die is shaped, and then operation confirmation can be immediately performed.

5. A product (seat-pad reinforcing cloth) molded using a molding die for molding a seat-pad reinforcing cloth is subjected to pick-and-place automatically by a dedicated demolding mechanism. Hooks for pick are installed on the molding die. Hence, a method of automatically demolding a seat-pad reinforcing cloth (receiving material for a spring) has been developed such that a product is first separated from a molding die, and then is picked up and placed.

Through manufacture of a seat-pad reinforcing cloth in such a manner, urethane foam grows uniformly even in a thinnest wall part of a urethane seat pad, and even when a seat-pad reinforcing cloth has a complicated shape, it is not required to prepare a larger material, and deburring work after molding is not required, thereby enabling eliminating manual work as much as possible.

### REFERENCE SIGNS LIST

10: manufacturing apparatus for seat-pad reinforcing cloth, 12: seat-pad reinforcing cloth material, 14: molding die, 16: seat upper ridge line portion, 18: upper end portion, 19: creases, 20: upper-end-portion heat-pressing molding device, 22: rear portion, 24: rear-portion heat-pressing molding device, 26: front portion, 28: front-portion heat-pressing molding device, 30, 32, 34: heat-pressing portion, 36: one side surface, 38: one-side-surface heat-pressing molding device, 40: another side surface, 42: another-side-surface heat-pressing molding device, 44: air bag part, 46: sandwiching heat-pressing molding device, 47: demolding mechanism, 48: arm part, 50: pickup part, 52: hollow die body, 54: suction port, 56: hook part, 58: crushed portion, 60: hook part for pick, 62: cutting line forming device, 64: laser beam, 68: cutting line, 100: seat back part, 66, 102: urethane seat pad, 104: seat-pad reinforcing cloth, 105: seat-pad reinforcing cloth material, 106: foaming mold (lower mold), 108: foaming mold (middle mold), 110: foaming mold (upper mold), 112: urethane raw liquid, 113: carbon dioxide, G: gas generated inside foaming mold, P: thin wall part.

1. A manufacturing method for a seat-pad reinforcing cloth which is to be used for a vehicular seat, the manufacturing method comprising a step of molding a seat upper ridge line portion of a seat-pad reinforcing cloth including:
a step of putting a seat-pad reinforcing cloth material over a molding die for molding the seat-pad reinforcing cloth, the seat-pad reinforcing cloth material being designed to have a shape fitting the molding die just right;
an upper-end-portion heat-pressing molding step of performing heat-pressing molding on an upper end portion of the seat upper ridge line portion of the seat-pad reinforcing cloth material put over the molding die, from above by an upper-end-portion heat-pressing molding device, to generate creases in a periphery of a rear part of a portion of the seat-pad reinforcing cloth material, which has been subjected to the heat-pressing molding from above;
a rear-portion heat-pressing molding step of performing heat-pressing molding by a rear-portion heat-pressing molding device on, together with the creases generated in the upper-end-portion heat-pressing molding step, a rear portion, which has not been subjected to the pressing molding by the upper-end-portion heat-pressing molding device, out of the seat upper ridge line portion of the seat-pad reinforcing cloth material put over the molding die; and
a front-portion heat-pressing molding step of performing heat-pressing molding by a front-portion heat-pressing molding device on a front portion, which has not been subjected to the heat-pressing molding by the upper-end-portion heat-pressing molding device, out of the seat upper ridge line portion of the seat-pad reinforcing cloth material put over the molding die,
wherein the molding die is a molding die made of a resin, which is shaped by a 3D printer and has a hybrid die structure formed of resins of different materials,
wherein the resins of different materials include a heat-resistant resin and a non-heat-resistant resin,
wherein a portion of the molding die, to which heat is to be applied by each of the upper-end-portion heat-pressing molding device, the rear-portion heat-pressing molding device and the front-portion heat-pressing molding device, is formed of the heat-resistant resin, and
wherein a portion of the molding die, to which no heat is to be applied by each of the upper-end-portion heat-pressing molding device, the rear-portion heat-pressing molding device and the front-portion heat-pressing molding device, is formed of the non-heat-resistant resin.

2. The manufacturing method for a seat-pad reinforcing cloth according to claim 1, further comprising, after the step of molding the seat upper ridge line portion:
a step of performing heat-pressing molding on one side surface of the seat-pad reinforcing cloth material put over the molding die;
a step of performing heat-pressing molding on another side surface of the seat-pad reinforcing cloth material put over the molding die; and
a step of automatically demolding the seat-pad reinforcing cloth material put over the molding die, by a demolding mechanism.

3. The manufacturing method for a seat-pad reinforcing cloth according to claim 2, wherein the step of performing heat-pressing molding on the one side surface and/or the another side surface of the seat-pad reinforcing cloth material put over the molding die is sandwiching heat-pressing molding for performing heat-pressing molding by sandwiching the one side surface and/or the another side surface of the seat-pad reinforcing cloth material put over an air bag part of the molding die.

4. The manufacturing method for a seat-pad reinforcing cloth according to claim 2, further comprising, before the step of automatically demolding by the demolding mechanism, a cutting line forming step of forming a cutting line in a part of the one side surface or the another side surface of the seat-pad reinforcing cloth material put over the molding die, along a ridge line of the one side surface or the another side surface.

5. A manufacturing apparatus for a seat-pad reinforcing cloth which is to be used for a vehicular seat, the manufacturing apparatus comprising:
a molding die over which a seat-pad reinforcing cloth material is to be put in order to mold the seat-pad reinforcing cloth, the seat-pad reinforcing cloth material being designed to have a shape fitting the molding die just right;
an upper-end-portion heat-pressing molding device configured to perform heat-pressing molding from above on an upper end portion of the molding die, out of a seat upper ridge line portion of the seat-pad reinforcing cloth material put over the molding die, to generate creases in a periphery of a rear part of a portion of the seat-pad reinforcing cloth material, which has been subjected to the heat-pressing molding from above;
a rear-portion heat-pressing molding device configured to perform pressing molding on, together with the creases generated due to the pressing molding by the upper-end-portion heat-pressing molding device, a rear portion, which has not been subjected to the pressing molding by the upper-end-portion heat-pressing molding device, out of the seat upper ridge line portion of the seat-pad reinforcing cloth material put over the molding die; and
a front-portion heat-pressing molding device configured to perform heat-pressing molding on a front portion, which has not been subjected to the heat-pressing molding by the upper-end-portion heat-pressing molding device, out of the seat upper ridge line portion of the seat-pad reinforcing cloth material put over the molding die,
wherein the molding die is a molding die made of a resin, which is shaped by a 3D printer and has a hybrid die structure formed of resins of different materials,
wherein the resins of different materials include a heat-resistant resin and a non-heat-resistant resin,
wherein a portion of the molding die, to which heat is to be applied by each of the upper-end-portion heat-pressing molding device, the rear-portion heat-pressing molding device and the front-portion heat-pressing molding device, is formed of the heat-resistant resin, and
wherein a portion of the molding die, to which no heat is to be applied by each of the upper-end-portion heat-pressing molding device, the rear-portion heat-pressing molding device and the front-portion heat-pressing molding device, is formed of the non-heat-resistant resin.

6. The manufacturing apparatus for a seat-pad reinforcing cloth according to claim 5, wherein a heat-pressing portion of the upper-end-portion heat-pressing molding device has a shape following a shape of an upper end portion of the molding die, a heat-pressing portion of the rear-portion heat-pressing molding device has a shape following a shape of a rear portion of the molding die, and a heat-pressing portion of the front-portion heat-pressing molding device has a shape following a shape of a front portion of the molding die.

7. The manufacturing apparatus for a seat-pad reinforcing cloth according to claim 5, wherein the seat upper ridge line portion of the seat-pad reinforcing cloth material put over the molding die is present on an upper side from a middle of the seat-pad reinforcing cloth material put over the molding die.

8. The manufacturing apparatus for a seat-pad reinforcing cloth according to claim 5, further comprising:
a one-side-surface heat-pressing molding device configured to perform heat-pressing molding on one side surface of the seat-pad reinforcing cloth material put over the molding die;
an another-side-surface heat-pressing molding device configured to perform heat-pressing molding on another side surface of the seat-pad reinforcing cloth material put over the molding die; and
a demolding mechanism configured to automatically demold the seat-pad reinforcing cloth material put over the molding die.

9. The manufacturing apparatus for a seat-pad reinforcing cloth according to claim 8, wherein the one-side-surface heat-pressing molding device and/or the another-side-surface heat-pressing molding device is a sandwiching heat-pressing molding device configured to perform heat-pressing molding by sandwiching the one side surface and/or the another side surface of the seat-pad reinforcing cloth material put over an air bag part of the molding die.

10. The manufacturing apparatus for a seat-pad reinforcing cloth according to claim 8, wherein the demolding mechanism includes a mechanism configured to perform pick-and-place on the seat-pad reinforcing cloth material put over the molding die.

11. The manufacturing apparatus for a seat-pad reinforcing cloth according to claim 8, further comprising a cutting line forming device configured to form a cutting line in a part of the one side surface or the another side surface of the seat-pad reinforcing cloth material put over the molding die, along a ridge line of the one side surface or the another side surface.

12. The manufacturing apparatus for a seat-pad reinforcing cloth according to claim 11, wherein the cutting line forming device is a CO₂ laser marker.

13. A molding die, which is to be used for the manufacturing apparatus for a seat-pad reinforcing cloth according to claim 5, and over which a seat-pad reinforcing cloth material designed to have a shape fitting the molding die just right is to be put,
the molding die comprising:
a hollow die body made of a resin, which is shaped by a 3D printer and has a hybrid die structure formed of resins of different materials;
a suction port formed in the hollow die body; and
a hook for pick provided on the hollow die body,
wherein the resins of different materials include a heat-resistant resin and a non-heat-resistant resin,
wherein a portion of the molding die, to which heat is to be applied by each of the upper-end-portion heat-pressing molding device, the rear-portion heat-pressing molding device and the front-portion heat-pressing molding device, is formed of the heat-resistant resin, and
wherein a portion of the molding die, to which no heat is to be applied by each of the upper-end-portion heat-pressing molding device, the rear-portion heat-pressing molding device and the front-portion heat-pressing molding device, is formed of the non-heat-resistant resin.

14. The manufacturing method for a seat-pad reinforcing cloth according to claim 1, further comprising a step of causing a portion of the seat-pad reinforcing cloth material, which is to be subjected to heat-pressing, to contain water in advance.

15. The manufacturing method for a seat-pad reinforcing cloth according to claim 1, further comprising, after the step of putting the seat-pad reinforcing cloth material over the molding die, a step of fixing the seat-pad reinforcing cloth material to the molding die by magnets.
